(19) United States
(12) Patent Application Publication
(10) Pub. No.: US 2012/0258235 A1
(43) Pub. Date: Oct. 11, 2012

(54) Spiced salt

(76) Inventor: Francois Patanchon, Encinitas, CA (US)

(21) Appl. No.: 13/506,435

(22) Filed: Apr. 17, 2012

Related U.S. Application Data
(63) Continuation-in-part of application No. 12/454,011, filed on May 12, 2009.

(51) Int. Cl. A23L 1/237

(52) U.S. Cl. 426/649

(57) ABSTRACT

The invention described herein is a process for making a spiced salt, the process comprising selecting table wine, admixing at least one selected spice with the selected table wine and agitating the admixture, then immersing a selected edible salt with the admixture of selected table wine and the at least one selected spice. The solution of wine, spice and salt are then macerated and agitated until the selected table wine has evaporated, thereby producing a spiced salt. The process may be accelerated by heating the solution.

This application is a continuation-in-part of application Ser. No. 12/454,011 filed May 12, 2009.

### FIELD OF THE INVENTION

This invention pertains to “spiced salt,” a process wherein edible salts and spices are macerated in wine to produce a spiced salt.

### BACKGROUND OF THE INVENTION

No directly relevant prior art was found in searching the invention. There are a series of patents in which the maceration process was used to produce sulfides and other aromatic flavors, but none of the patents were directed to the maceration of a table salt. These patents are represented by U.S. Pat. Nos. 4,045,491, 4,061,796, 4,107,197 and is 4,119,788, all to Evers, et al. U.S. Pat. No. 7,192,731 to Kanner, et al. describes a process of maceration of pectins, proteins and cellulose, respectively, and a lipase. However, none of the listed patents discloses a maceration process of table wines, spices and salts.

### SUMMARY OF THE INVENTION

The invention described herein is a process for making a spiced salt, the process consisting of selecting table wine, admixing at least one selected spice with the selected table wine and agitating the admixture, then immersing a selected edible salt with the admixture of selected table wine and the at least one selected spice. The solution of wine, spice and salt are then macerated and agitated until the selected table wine has evaporated, thereby producing a spiced salt.

### DETAILED DESCRIPTION OF THE INVENTION

No drawings have been submitted with this application as a drawing is not necessary for understanding the subject sought to be patented. The invention is a maceration process in which three or more ingredients are admixed in one container, an edible salt, at least one selected spice, and a selected table wine. The edible salt may be either sea salt or rock salt.

Salts. Sea salt is harvested from seawater through evaporation. Table salt is typically from rock salt, which is mined from mineral deposits. Both types of salt can be fully refined, and the end result is pure sodium chloride (NaCl). Sea salt is available in fine or coarse grain. Sea salt has a slightly different taste than table salt because of different minerals it contains. Many people prefer sea salt to table salt because they claim it has a more subtle flavor. Sea salt doesn't contain iodine or any other additives. However, if sea salt is used, typically one does not have to worry about not getting enough iodine in their diet because iodine is available in many other foods, including dairy products, seafood and many processed foods.

Table salt is a fine-grained salt that often contains added iodine (iodized salt). Iodine is necessary for normal thyroid function. Some table salt may also contain anti-caking ingredient.

In the preferred embodiment of the invention “Fleur de Sel de Camargue” (“Flower of Salt,” also known as the “Caviar of Salt”), also known as sel gris or grey salt, a sea salt from the coastal area of Camargue, Mediterranean, France will be used. The salt is “moist” and unrefined. It remains a light grey. The salt is not collected by machine but by hand using traditional methods. It is available in coarse grain. It is considered by many to be the best quality salt available. Fleur De Sel de Camargue is hand raked and harvested in France. The name Fleur De Sel comes from the aroma of violets that develops as the salt dries. Only the premium, top layer of the salt bed is used. Unlike processed salts, Fleur De Sel is a natural source of potassium, calcium, magnesium, copper and iodine. The taste is a delicate balance of the numerous salts, minerals, and micronutrients; this is truly the best salt available. In a second preferred embodiment of the invention, a salt known as Sel de Guerande, or any other type of edible sea salt or rock salt may be used.

Wines. For the invention, two different types of table wines have been selected: red wine and white wine. An advantage of wine is that it serves as a vehicle for flavoring since many spices are soluble in alcohol. The color of the final product will depend on the wine used during the salt maceration process. Different spices will be used with the red wine or the white wine. The flavor of the final product will be different, depending on the wine and spices used. In the process using red wine, preferably a wine known as “Cabernet Sauvignon” will be used. The grape itself is very small, with a thick skin, creating a high 1:12 ratio of seed (pip) to fruit (pulp). From these elements the high proportions of phenols and tannins can have a stark influence on the structure and flavor of the wine, especially if the “must” (the skin of the grapes) is subjected to long periods of maceration (skin contact) before fermentation. The results of these long maceration periods are very tannic and flavorful wines with a dark red color: this is the characteristics that are needed for maceration of the table wine with the salt. As the “must” is exposed to prolonged periods of maceration, more tannin is extracted from the skin and will be present in the resulting wine. The tannic nature of the wine is an important consideration in the invention. It should be understood that the maceration process for making the wines is not a part of the invention.

The maceration of the red wine altogether with the salt and the spices will maximize color and flavor concentrations on the salt crystals. Although red wine maceration has been described in terms of a cabernet sauvignon, other red wines may be selected.

Every kind of white wine can be used for the invention, but it is preferably to use chardonnay because of its popularity in California and the Californian wine regions seem to favor producing premium quality chardonnay. As the salt is exposed to prolonged periods of maceration, more tannin is extracted from the Wine and will be present in the salt crystals.

Spices. Admixed with the salt is any, or a combination of spices, selected from the group of paprika, garlic powder, black pepper, red pepper, dried onion, lemon, sunflower oil, porcini mushroom, sage, thyme, basil, mustard seed, curry and saffron. The spice, or selected spices, are mixed altogether and grinded to obtain a fine powder. The finer the powder is the better it is because it will facilitate the absorption of the molecules of spices by the crystal of salt during the maceration step. The mix between the spices is not exactly the same between the red wine process and the white wine process. For example Saffron and Lemon are not used for the red salt, but only in the process to obtain a yellow salt. The color of the yellow salt will come mainly from the saffron, lemon and other spices, more than from the white wine itself. It is not intended that the listed spices should be exclusive. Other spices may be found that are compatible with the selected wines and salts, and should be considered part of the invention.

Method. The process of “maceration,” wetting, or steeping in a fluid, is used to both flavor and colorize the salt. The spices are reduced to a very fine powder, and about 100 to 200 grams of the spices are added to about one liter of table wine, and then the admixture is periodically agitated, either by stirring or by aeration. The wine and the spices marinate together for a selected time period in stainless steel buckets, then about two kilograms of salt is added to the admixture so that the admixture of salt and spices is totally immersed in the wine, and periodically stirred every 4 hours for a period of time between 2 days and 5 days until wine evaporates and the salt and spices are reduced to dry crystals. The period of maceration is selected such that the spices are fully absorbed on the salt. The alcohol of the wine serves as a vehicle to bring the molecules of spices and the flavor of the spices into the crystals of salt.

The salt is then steeped with the admixture of table wine and spices until the wine evaporates, leaving the dry spiced crystals of salt. In this maceration process, the phenolic materials of the wine (tannins), the coloring agents (anthocyanins), and the combined flavor compounds of the wine itself and the flavors from the spices are leached into the crystals of salt. The main object of the present invention is to facilitate extraction of anthocyans (color) and polyphenolic substances (tannins) from the wine, while the wine will serve at the same time as a vehicle for flavoring since many flavors of the added spices are soluble in alcohol, and in a more general sense while strongly increasing the quantity and quality of substances transferred to the salt during the maceration.

In the preferred embodiment, the wine with the spices reduced in extra fine powder and the salt will macerate for 2 to 5 days (depending of the color salt desired). The longer the maceration period, the deeper the color of the salt will be, and the more flavor will be transmitted from the liquid to the crystals of salt. The selected ratio of salt to wine is about 1 volume of salt for ⅓ volume of wine. This ration of salt to wine is not a critical aspect of the invention. One of ordinary skill in the art will recognize that there must be a sufficient volume of wine to fully immerse the salt. The maceration process is aided by periodic agitation, either stirring or aeration, of the wine/spice/salt admixture. Aeration of the admixture would accelerate the maceration process. The temperature of the admixture is held to constant temperatures of about 20° C. (68° F.) to about 40° C. (104F), with about 30° C. (86° F.) preferable. In the heated maceration process of manufacturing that is preferred, the salt will last between 48 hours and 120 hours at a temperature of 30° C. (86° F.). Deeper colors and more flavorful components will be extracted at these temperatures from the solution, and transmitted to the crystals of salt, essentially maximizing color and flavor concentrations. The larger the quantity of salt and wine, the longer it will take to accomplish the maceration. The maceration step is terminated when the wine has evaporated, and the salt is dry and no longer moist.

After a period of two to five days, all the wine and the spices will be absorb by the crystal of salt, the salt will be totally dry and the crystals of salt will have soaked up the flavor of the added spices as well as the natural flavor of the wine. The crystals of salt will also have absorb the natural coloring agents of the wine and will have a natural red/ruby color when red wine is used in the maceration, or yellow when the white wine is used in the maceration.

The process of maceration begins, to varying extent, as soon as the wine, spices and salt are admixed. The rate of absorption of the spices is accelerated when the admixture is exposed to some degree of heat. Temperature is the guiding force with higher temperatures encouraging more breakdown and extraction of phenols and flavor from the wine. Depending on the maceration time, the process of maceration will help bring out many flavors into the crystals of salt. Maceration can enhance the flavor as well as strengthen the red or yellow color. It should be understood that the period of maceration will be dependent on the ratio of the volume of wine to the volume of salt. The higher the ratio, the longer the maceration process required. Also, the cooler the ambient temperature for the maceration, the longer the period of maceration.

In a second embodiment, the evaporation of the wine may be accelerated by macerating the admixture of wine, spices and salt at elevated temperatures, (40° C. (104F) and higher), and for shorter time periods. At these elevated temperatures, additional agitation, i.e., stirring or aeration, may be required. The elevated temperature may be induced by either convection or irradiation. When macerated at higher temperatures the process is faster but the transfer of the colors and flavors contained in the wine to the salt crystals will not be as efficient.

The process is even faster using a microwave oven, and it will then only takes few minutes to complete evaporation of the wine, but only a very few of the wine flavors and spices will be transferred to the salt. Even if the aspect and color are the same, the flavor and the taste will be very different.

Although preferred embodiments of the invention have been described herein in detail, it will be understood that those skilled in the art can make modifications thereto without departing from the spirit of the invention or the scope of the appended claims.

1. A process for making a spiced salt, the process comprising the steps of:
(a) selecting a table wine,
(b) admixing at least one selected spice with the selected table wine;
(c) immersing a selected edible salt in the admixture of the selected table wine and the at least one selected spice to create a wine/spice/salt solution, wherein ratio of the weight of the at least one spice is between about 5 to about 10 percent of the weight of the salt; and
(d) macerating the solution for a period of between 2 and 5 hours until the selected table wine has evaporated, producing dry spiced crystals of salt: and
(e) periodically agitating the immersed solution during the step of macerating for a period of between about 2 to about 5 days until the selected table wine has evaporated, producing dry spiced crystals of salt.

2. The process of claim 1 wherein the step of admixing the at least one selected spice with the selected table wine includes the step of agitating the admixture.

3. The process of claim 1 wherein the step of macerating the solution includes the step of agitating the solution.

4. The process of claim 1 wherein the step of macerating the solution includes the step of heating the solution to a selected temperature.

5. The process of claim 1 wherein the selected table wine is a red table wine.

6. The process of claim 1 wherein the selected table wine is a white table wine.

7. The process of claim 1 wherein the at least one selected spice is selected from the group of paprika, garlic powder, black pepper, red pepper, dried onion, lemon, sunflower oil, porcini mushroom, sage, thyme, basil, mustard seed, curry and saffron.

8. A process for making a spiced salt, the process comprising the steps of:
(a) selecting a table wine,
(b) admixing at least one selected spice with the selected table wine;
(c) immersing a selected edible salt in the admixture of the selected table wine and the at least one selected spice to create a wine/spice/salt solution;
(d) agitating the solution; and
(e) macerating the solution for a period of between 2 and 5 hours until the selected table wine has evaporated_producing dry spiced crystals of salt.

9. The process of claim 8 wherein the step of admixing the at least one selected spice with the selected table wine includes the step of agitating the admixture.

10. The process of claim 8 wherein the step of macerating the solution includes the step of heating the solution to a selected temperature.

11. The process of claim 8 wherein the selected table wine is a red table wine.

12. The process of claim 8 wherein the selected table wine is a white table wine.

13. The process of claim 8 wherein the at least one selected spice is selected from the group of paprika, garlic powder, black pepper, red pepper, dried onion, lemon, sunflower oil, porcini mushroom, sage, thyme, basil, mustard seed, curry and saffron.

14. A spiced salt, made by the process comprising the steps of:
(a) selecting a table wine,
(b) admixing at least one selected spice with the selected table wine;
(c) agitating the admixture for a selected time;
(c) immersing a selected edible salt in the admixture of the selected table wine and the at least one selected spice to create a wine/spice/salt solution, wherein ratio of the weight of the at least one spice is between about 5 to about 10 percent of the weight of the salt;
(d) agitating the solution; and
(e) macerating the solution for a period of between 2 and 5 hours until the selected table wine has evaporated to produce dry spiced crystals of salt.

15. The spiced salt of claim 14 wherein the step of macerating the solution includes the step of heating the solution to a selected temperature.

16. The spiced salt of claim 14 wherein the selected table wine is a red table wine.

17. The spiced salt of claim 14 wherein the selected table wine is a white table wine.

18. The spiced salt of claim 14 wherein the at least one selected spice is selected from the group of paprika, garlic powder, black pepper, red pepper, dried onion, lemon, sunflower oil, porcini mushroom, sage, thyme, basil, mustard seed, curry and saffron.
